(19) United States
(12) Patent Application Publication
(10) Pub. No.: US 2023/0130948 A1
(43) Pub. Date: Apr. 27, 2023

(54) HEATING MODULE AND SMOKING DEVICE

(71) Applicant: HUIZHOU PEGASUS TECHNOLOGY CO., LTD., Huizhou, Guangdong (CN)

(72) Inventors: Huabin YAN, Huizhou, Guangdong (CN); Zhiliang DENG, Huizhou, Guangdong (CN)

(21) Appl. No.: 17/616,659

(22) PCT Filed: Dec. 18, 2020
(86) PCT No.: PCT/CN2020/137715

§ 371 Date: Dec. 5, 2021

(30) Foreign Application Priority Data
Jul. 17, 2020 (CN) 202010692946.4

(51) Int. Cl. A24F 40/46; H05B 1/02; H05B 3/12

(52) U.S. Cl. CPC A24F 40/46; H05B 1/0291; H05B 3/12

(57) ABSTRACT

A heating module and a smoking device are provided by the present application. In the heating module, a heating assembly includes a supporting member and a heating coil. At least part of the heating coil is arranged on the supporting member. A housing member is disposed around an outer peripheral side of the heating assembly. A groove is arranged in an external surface of the supporting member. The heating coil includes a heating main body, and the heating main body twines inside the groove.

### BACKGROUND OF THE INVENTION

### Field of Invention

The present application relates to smoking device technology, and particularly to a heating module and a smoking device.

### Description of Prior Art

Heating modules in prior art generally include a housing member and a heating coil arranged inside the housing member. Such kind of heating modules are simple in structure, but heating modules with such structures generate heat non-uniformly during use, resulting in poor quality of products produced by heating.

### SUMMARY OF INVENTION

Embodiments of the present application provide a heating module and a smoking device to solve the problem of non-uniform heat generating during use of the heating modules in prior art.

A heating module is provided by the embodiments of the present application, including:

a heating assembly including a supporting member and a heating coil, wherein at least part of the heating coil is arranged on the supporting member; and

a housing member disposed around an outer peripheral side of the heating assembly;

wherein a groove is arranged in an external surface of the supporting member, wherein the heating coil includes a heating main body, and the heating main body twines inside the groove.

In the heating module of the embodiments of the present application, the supporting member includes a supporting main body and an insulating layer, and the insulating layer is disposed on an external surface of the supporting main body.

In the heating module of the embodiments of the present application, a thermal conductivity of the supporting main body is greater than or equal to 80 W/m·K.

In the heating module of the embodiments of the present application, the supporting main body and the insulating layer are integrally formed by an insulating material.

In the heating module of the embodiments of the present application, a material of the supporting main body is metal, and a material of the insulating layer includes metal oxide formed on the supporting main body.

In the heating module of the embodiments of the present application, the material of the supporting main body is aluminum, and the material of the insulating layer includes zirconia formed on the supporting main body.

In the heating module of the embodiments of the present application, the material of the supporting main body is one of gold, silver, copper, iron, aluminum or alloy, and the material of the insulating layer includes one of alumina ceramics and zirconia.

In the heating module of the embodiments of the present application, the heating module further includes a thermal conductive adhesive, and the thermal conductive adhesive fills a gap between the heating assembly and the housing member.

In the heating module of the embodiments of the present application, the thermal conductive adhesive is selected from ceramic inorganic adhesives or inorganic adhesives of glass enamel.

In the heating module of the embodiments of the present application, the heating coil further includes two pins and a conductive layer, the pins are connected to the heating main body, the conductive layer covers the periphery of the pins, and a resistivity of the conductive layer is lower than a resistivity of the pins.

In the heating module of the embodiments of the present application, a material of the pins differs from a material of the heating main body, and the resistivity of the pins is lower than a resistivity of the heating coil.

In the heating module of the embodiments of the present application, a material of the pins is the same as a material of the heating main body, and the pins are integrally formed with the heating main body.

In the heating module of the embodiments of the present application, a material of the conductive layer is selected from one or a combination of more than two of silver, copper, and gold.

In the heating module of the embodiments of the present application, the groove includes a first groove, a second groove and a third groove, the second groove is connected to an end of the first groove, and the third groove is connected to another end of the first groove; and

the first groove is arranged in a top of the supporting member, either of the second groove and the third groove twines from the top of the supporting member to a bottom of the supporting member, respectively, and the second groove and the third groove are disposed at an interval;

the heating main body includes a first heating section, a second heating section and a third heating section, the second heating section is connected to an end of the first heating section, the third heating section is connected to another end of the first heating section; and

the first heating section is disposed inside the first groove, the second heating section is disposed inside the second groove, and the third heating section is disposed inside the third groove.

In the heating module of the embodiments of the present application, the first groove is disposed on a central line of the top of the supporting member.

In the heating module of the embodiments of the present application, a through-hole penetrating the supporting member is provided in the supporting member, a depth direction of the through-hole is an extending direction of the supporting member; and

the groove in a shape of a screw thread is provided in a peripheral wall of the supporting member, the heating main body twines in the groove, one of the pins of the heating coil is connected to an end of the heating main body and extends into the through-hole and out of the supporting member; and another one of the pins of the heating coil is connected to another end of the heating main body, and also extends out of the supporting member.

In the heating module of the embodiments of the present application, a first groove and a second groove are provided in a peripheral side of the supporting member, and either of the first groove and the second groove twines form a top of the supporting member to a bottom of the supporting member, respectively, the first groove and the second groove disposed at an interval;

the heating main body includes a first heating section, a second heating section and a third heating section, the second heating section is connected to one end of the first heating section, the third heating section is connected to another end of the first heating section; and

the first heating section is mounted on the top of the supporting member, the second heating section is disposed inside the first groove, and the third heating section is disposed inside the second groove.

A smoking device is also provided by the embodiments of the present application including anyone of the heating module in the above embodiments.

For example, a smoking device of the embodiments of the present application, including a heating module, wherein the heating module includes:

a heating assembly including a supporting member and a heating coil, wherein at least part of the heating coil is arranged on the supporting member; and

a housing member disposed around an outer peripheral side of the heating assembly;

wherein a groove is arranged in an external surface of the supporting member, wherein the heating coil includes a heating main body, and the heating main body twines inside the groove.

In the smoking device of the embodiments of the present application, the supporting member includes a supporting main body and an insulating layer, and the insulating layer is disposed on the external surface of the supporting member.

In the smoking device of the embodiments of the present application, a thermal conductivity of the supporting main body is greater than or equal to 80 W/m·K.

According to the heating module of this embodiment, the heating coil is arranged on the supporting member to form the heating assembly, and the heating assembly is used as heat source to heat the housing member to improve the overall heating uniformity of the heating module; moreover, the thermal conductive adhesive 10c is used to fill the gap between the heating module and the housing member, which allows the heating module transfer heat uniformly to the housing member, so as to improve the overall heating uniformity of the heating module.

### BRIEF DESCRIPTION OF DRAWINGS

In order to describe technical solutions in the present invention clearly, drawings to be used in the description of embodiments will be described briefly below. Apparently, drawings described below are only for some embodiments of the present invention, and other drawings may be obtained by those skilled in the art based on these drawings without creative efforts.

FIG. 1 is a structural schematic diagram of a heating module of the embodiments of the present application;

FIG. 2 is a cross-sectional view of the heating module of the embodiments of the present application;

FIG. 3 is an exploded diagram of the heating module of the embodiments of the present application;

FIG. 4 is a structural schematic diagram of a housing member of the heating module of the embodiments of the present application;

FIG. 5 is a structural schematic diagram of a heating assembly of the heating module of the embodiments of the present application;

FIG. 6 is an exploded diagram of the heating assembly of the embodiments of the present application;

FIG. 7 is a cross-sectional view of a supporting member of the heating module of the embodiments of the present application;

FIG. 8 is a heating effect diagram of a heating module in prior art;

FIG. 9-a is diagram illustrating the temperature of the supporting member in a heating effect diagram of the heating module of the embodiments of the present application;

FIG. 9-b is diagram illustrating the temperature of the housing member in a heating effect diagram of the heating module of the embodiments of the present application;

FIG. 10 is an exploded diagram of another structure of the heating assembly of the heating module of the embodiments of the present application;

FIG. 11 is an exploded diagram of another structure of the heating assembly of the heating module of the embodiments of the present application. Here is an illustration of marks: in FIG. 8 to FIG. 9-b, the mark “+” indicates position in the heating module; and the marks P0-P13 indicate serial numbers.

### DETAILED DESCRIPTION OF EMBODIMENTS

The present application is further described in detail below with reference to the accompanying drawings and embodiments. Obviously, the following described embodiments are only part of the present disclosure but not all. A person having ordinary skill in the art may obtain other embodiments based on the embodiments provided in the present disclosure without making any creative effort, which all belong to the scope of the present disclosure.

In the description of the present disclosure, it should be understood that terms such as “center,” “longitudinal,” “lateral,” “length,” “width,” “thickness,” “upper,” “lower,” “front,” “rear,” “left,” “right,” “vertical,” “horizontal,” “top,” “bottom,” “inside,” “outside,” “clockwise,” “counter-clockwise” as well as derivative thereof should be construed to refer to the orientation as then described or as shown in the drawings under discussion. These relative terms are for convenience of description, do not require that the present disclosure be constructed or operated in a particular orientation, and shall not be construed as causing limitations to the present disclosure. In addition, terms such as “first” and “second” are used herein for purposes of description and are not intended to indicate or imply relative importance or significance. Thus, features limited by “first” and “second” are intended to indicate or imply including one or more than one these features. In the description of the present disclosure, “a plurality of” relates to two or more than two, unless otherwise specified.

In the description of the present disclosure, it should be noted that unless there are express rules and limitations, the terms such as “mount,” “connect,” and “bond” should be comprehended in broad sense. For example, it can mean a permanent connection, a detachable connection, or an integrate connection; it can mean a mechanical connection, an electrical connection, or can communicate with each other; it can mean a direct connection, an indirect connection by an intermediate, or an inner communication or an inter-reaction between two elements. A person skilled in the art should understand the specific meanings in the present disclosure according to specific situations.

In the description of the present disclosure, a structure in which a first feature is “on” a second feature may include an embodiment in which the first feature directly contacts the second feature, and may also include an embodiment in which an additional feature is formed between the first feature and the second feature so that the first feature does not directly contact the second feature, unless otherwise specified. Furthermore, a first feature “on”, “above”, or “on top of” a second feature may include an embodiment in which the first feature is right “on”, “above” or “on top of” the second feature, and may also include an embodiment in which the first feature is not right “on”, “above” or “on top of” the second feature, or just means that the first feature has a sea level elevation larger than the sea level elevation of the second feature. While first feature “beneath”, “below” or “on bottom of” a second feature may include an embodiment in which the first feature is right “beneath”, “below” or “on bottom of” the second feature, and may also include an embodiment in which the first feature is not right “beneath”, “below” or “on bottom of” the second feature, or just means that the first feature has a sea level elevation smaller than the sea level elevation of the second feature.

The disclosure herein provides many different embodiments or examples for realizing different structures of the present disclosure. In order to simplify the disclosure of the present disclosure, components and settings of specific examples are described below. Of course, they are only examples and are not intended to limit the present disclosure. Furthermore, reference numbers and/or letters may be repeated in different examples of the present disclosure. Such repetitions are for simplification and clearness, which do not indicate the relations of the discussed embodiments and/or settings. Moreover, the present disclosure provides examples of various specific processes and materials, but the applicability of other processes and/or application of other materials may be appreciated by a person skilled in the art.

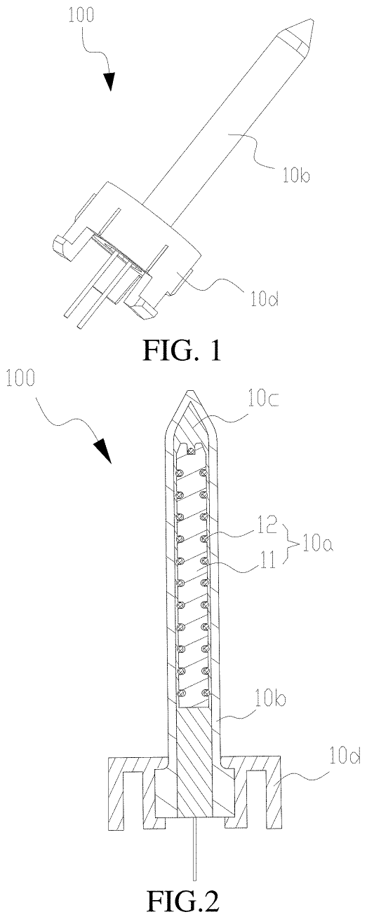

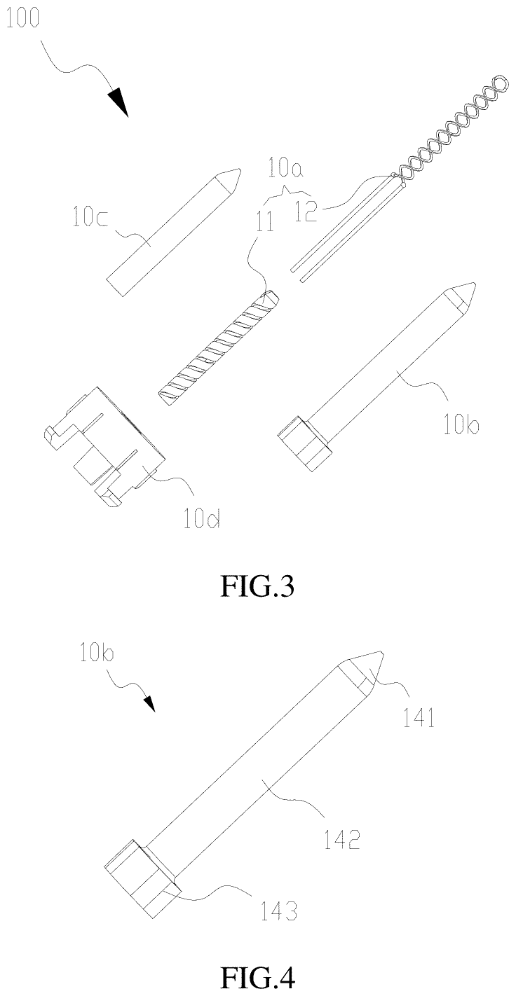

Please refer to FIG. 1 to FIG. 3, FIG. 1 is a structural schematic diagram of a heating module of the embodiments of the present application; FIG. 2 is a cross-sectional view of the heating module of the embodiments of the present application; FIG. 3 is an exploded diagram of the heating module of the embodiments of the present application.

The embodiment provides a heating module 100 which includes a heating assembly 10a, a housing member 10b, a thermal conductive adhesive 10c, and a fixing member 10d.

The heating assembly 10a includes a supporting member 11 and a heating coil 12. At least part of the heating coil 12 is arranged on the supporting member 11.

The housing member 10b is disposed around an outer peripheral side of the heating assembly 10a. The thermal conductive adhesive 10c fills a gap between the heating assembly 10a and the housing member 10b.

The housing member 10b is in a plug-in coordination with the fixing member 10d. The fixing member 10d is configured to fix the heating assembly 10b provided with the heating assembly 10a and the thermal conductive adhesive 10c into a smoking device. The smoking device can be an electronic cigarette, or other devices. The electronic cigarette is illustrated as an example in the embodiment, but the smoking device is not limited to electronic cigarette.

According to the heating module 100 of this embodiment, the heating coil 12 is arranged on the supporting member 11 to form the heating assembly 10a, and the heating assembly 10a is used as heat source to heat the housing member 10b to improve the overall heating uniformity of the heating module 100; moreover, the thermal conductive adhesive 10c is used to fill a gap between the heating assembly 10a and the housing member 10b, which allows the heating assembly 10a transfer heat uniformly to the housing member 10b, so as to improve the overall heating uniformity of the heating module 100.

In the heating module 100 of the embodiments of the present application, the thermal conductive adhesive 10c is selected from ceramic inorganic adhesives or inorganic adhesives of glass enamel. The inorganic adhesive fills in the gap between the heating assembly 10a and the housing member 10b. The thermal conductive adhesive 10c transfers heat generated by the heating assembly 10a rapidly to the housing member 10b to solve the problems of low heat conduction rate and poor heat conduction uniformity caused by air conduction of heat. At the same time, water and oxygen are prevented from entering the interior of the heating module 100 and eroding the heating coil 12.

When the heating module 100 is applied in the smoking devices, the thermal conductive adhesive 10c should be high temperature resistant inorganic adhesive.

In addition, the thermal conductive adhesive 10c can be filled by vacuum defoaming process or by means of vibration, or a combination of the above two processes, so that no bubbles is left in the thermal conductive adhesive 10c to improve thermal conductivity.

Please refer to FIG. 4, in the housing member 10b, a material of the housing member 10b includes but not limited in ceramic. The housing member 10b includes a cone part 141, a cylinder part 142 and a base 143 connected in a sequence. The cylinder part 142 is in a transition connection with the base 143 by an arc structure. The housing member 10b is integrally formed to improve stability.

In some embodiments, the housing member 10b includes a flat sword body part and a base connected to the sword body part. It should be understood that the housing member 10b can be other structures, which is not described here.

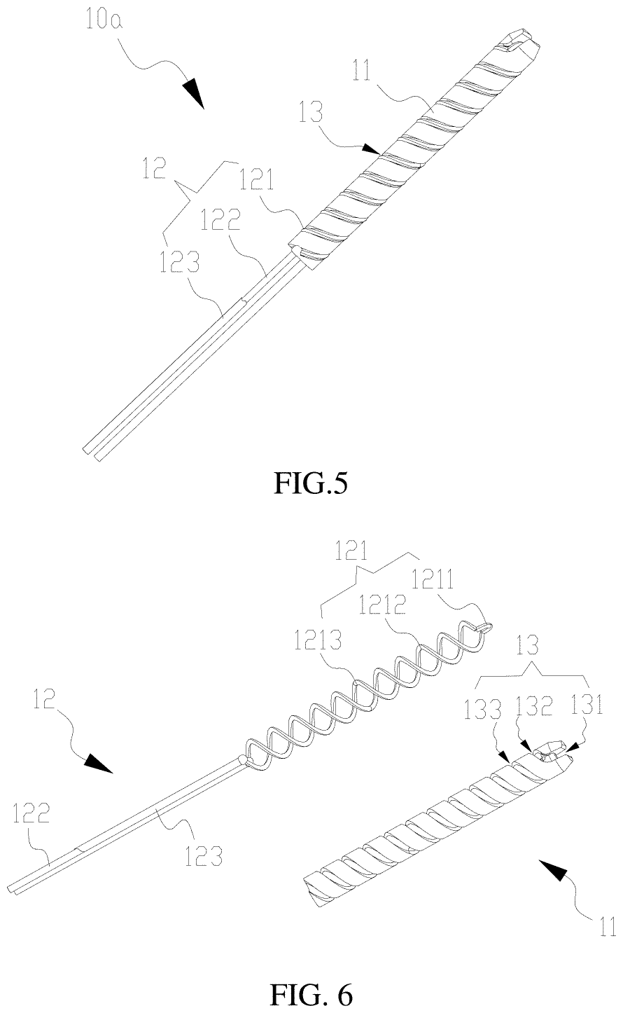

Please refer to FIG. 5 and FIG. 6, in the heating assembly 10a, a groove 13 is arranged in an external surface of the supporting member 11, and part of the heating coil 12 is disposed inside the groove 13.

The groove 13 is arranged in the external surface of the supporting member 11, and the heating coil 12 is disposed inside the groove 13. In one aspect, position of the heating coil 12 can be limited to prevent the heating coil from moving during installation; in another aspect, a shape of the groove 13 matches a shape of the heating coil 12, and the groove 13 fits the heating coil 12, which increases a contacting area between the heating coil 12 and the supporting member 11, further improving heating efficiency of the supporting member 11; moreover, during the installation of the heating assembly 10a, the groove 13 functions as a guide, which means a wire material of the heating coil 12 can be twined along and in the groove 13 using an automatic winding machine, which is simple and fast, and improves manufacturing efficiency. At the same time, short circuit between twined wire groups of the heating coil 12 can be avoided.

Optionally, the supporting member 11 can be in a cylinder-like shape; specifically, a top of the supporting member 11 has a shape of circular truncated cone, and a bottom of the supporting member 11 has a shape of cylinder, which is not limited. For example, an area of the supporting member 11 increases along a direction from the top of the supporting member 11 to the bottom of the supporting member 11, for example, in a shape of circular truncated cone. As the heating assembly 10a is plugged in the housing member 10b, such configuration can further prevent the heating coil 12 from moving towards the bottom of the supporting member 11, namely, to prevent the moving of the heating coil 12.

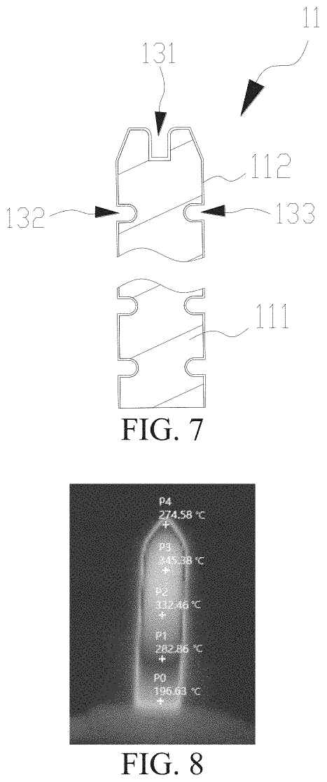

In the heating module 100 of the embodiment, please refer to FIG. 7, the supporting member 11 includes a supporting main body 111 and an insulating layer 112. The insulating layer 112 is disposed on an external surface of the supporting main body 111. The configuration of the insulating layer 112 can prevent short circuit of the heating coil 12.

In this embodiment, a material of the insulating layer 112 differs from a material of the supporting main body 111.

In other embodiments, the material of the insulating layer 112 can be the same as the material of the supporting main body 111. Specifically, the supporting main body 111 can be integrally formed with the insulating layer 112 using an insulating material, for example, ceramic.

A thermal conductivity of the supporting main body 111 is greater than or equal to 60 W/m·K. Materials of high thermal conductivity is used to make the supporting main body 111, so that heat generated by the heating coil 12 can be transferred to the supporting member 11 rapidly and uniformly, to allow the whole heating assembly 10a generates heat rapidly and uniformly, and transfer heat to the housing member 10b through the thermal conductive adhesive 10c uniformly, and eventually keep temperature of each part of the housing member 10b consistent.

Preferably, the thermal conductivity of the supporting main body 111 is greater than or equal to 80 W/m·K to further improve the overall heating uniformity of the heating assembly 10a. For example, the thermal conductivity of the supporting main body 111 can be 90 W/m·K, 100 W/m·K, 110 W/m·K or 120 W/m·K.

Optionally, the material of the supporting main body 111 is metal, but not limited to metal, for example, the material of the supporting main body 111 can be SiC (silicon carbide), graphene etc. The material of the insulating layer 112 includes metal oxide formed on the supporting main body, but not limited to metal oxide, for example, can be high temperature resistant inorganic materials etc.

Furthermore, the material of the supporting main body 111 is one of gold, silver, copper, iron, aluminum or alloy. A material of the insulating layer 111 includes one of alumina ceramics and zirconia. For example, the material of the supporting main body 111 is aluminum, and the material of the insulating layer 112 includes zirconia formed on the supporting main body 111. That is to say, an anodic oxidation insulating treatment is performed to a surface of the supporting main body 111 to form a dense zirconia film layer (insulating layer 112). Wherein, in one aspect, the dense zirconia film layer has a great hardness and a function of preventing current, which can prevent short circuit between the twined wire groups of the heating coil 12; in another aspect, the supporting main body 111 made by aluminum has a great thermal conductivity which is inductive to transferring heat rapidly; moreover, oxidation is performed on the surface of the supporting main body 111 to form the insulating layer 112, which improves manufacturing efficiency.

Certainly, in the embodiment, the supporting main body 111 can made of other materials, which is not described here.

In the heating module 100 of the embodiments, please refer to FIG. 6, the heating coil 12 includes a heating main body 121, two pins 122 and a conductive layer 123. The pins 122 are connected to the heating main body 121, and the conductive layer 123 covers the periphery of the pins 122.

The heating main body 121 is twined on the external surface of the supporting member 111 and disposed in the groove 13. The heating main body 121 is disposed in the groove 13 in a twined way, which improves a contact area between the heating main body 121 and the supporting member 11, thereby improves the heating efficiency of the supporting member 11.

Optionally, the heating main body 121 is twined on the supporting member 11 in a screw thread shape to improve the heating uniformity of the heating assembly 10a.

Optionally, the heating main body 121 is twined on the supporting member 11 uniformly to improve the heating uniformity of the heating assembly 10a; certainly, the heating main body 121 can be twined on the supporting member 11 non-uniformly.

Beside, in the heating assembly 10a of the embodiment, a resistivity of the conductive layer 123 is lower than a resistivity of the pins 122.

At present, most of the heating coil are powered by pulse width modulation (PWM), which can be regarded as a high-frequency alternating current. Most of the current is concentrated in the “skin” part of the heating coil, that is, the current is concentrated in an thin layer of an external surface of the heating coil, and the closer to the surface of the heating coil, the greater the current density is. Therefore, by forming a material of low resistivity on an surface of the pins 122 of the heating coil 12, the resistivity of a surface of an pin section of the heating coil 12 (which means the pins 122 provided with the conductive layer 123) can be reduced in to an extremely low level to greatly reduce heat generated by the pin section.

In addition, the resistance of the whole part of the heating coil (pin section plus the heating main body 121) is detected in TCR temperature control, by reducing the resistance of the pin section, so as to improve the proportion of the resistance of the heating main body 121, which allows a more accurate temperature control and a better reflection of the actual situation of the heating coil.

Optionally, a material of the conductive layer 123 is selected from one or a combination of more than two of silver, copper and gold, but not limited to that. In addition, the conductive layer 123 can be formed on the pins 122 by electroplating, evaporation or atomic deposition way.

Moreover, the material of the heating main body 121 differs from the material of the pins 122 for a further more accurate temperature control. A resistivity of the pins 122 is lower than a resistivity of the heating main body 121. The heating main body 121 are connected to the pins 122 by welding.

In some embodiments, the heating main body 121 and the pins 122 can be integrally formed. The material of the heating main body 121 is the same as the material of the pins 122, which can be nickel, Fe—Ni alloy or other conductive materials.

Specifically, please refer to FIG. 5 and FIG. 6, in the heating assembly 10a of this embodiment, the groove 13 includes a first groove 131, a second groove 132 and a third groove 133, the second groove 132 is connected to an end of the first groove 131, and the third groove 133 is connected to another end of the first groove 131.

The first groove 131 is arranged in a top of the supporting member 11. Either of the second groove 132 and the third groove 133 twines from the top of the supporting member 11 to a bottom of the supporting member 11, respectively. The second groove 132 and the third groove 133 are disposed at an interval.

The heating main body 121 includes a first heating section 1211, a second heating section 1212 and a third heating section 1213. The second heating section 121 is connected to an end of the first heating section 1211, the third heating section 1213 is connected to another end of the first heating section 1211.

The first heating section 1211 is disposed in the first groove 131. The second heating section 1212 is disposed in the second groove 132. The third heating section 1213 is disposed in the third groove 133.

Wherein, the first groove 131 is disposed on the top of the supporting member 11, and the first heating section 1211 of the heating main body 121 is disposed in the first groove 131 to fix the specific position of the heating coil 12, namely, to prevent the heating coil 12 from move in the horizontal plane during installation.

Optionally, the first groove 131 is provided on a central line of the top of the supporting member 11 to limit the heating coil 12 to a center position of the supporting member 11, to improve the heating uniformity of the heating assembly 10a.

It should be noted that the central line refers to a line which divides the supporting member 11 into two identical parts, for example, the supporting member 11 is cylindrical and a top surface of the top of the supporting member 11 is circular, a connecting line along a diameter of the top surface is the center line; if the supporting member 11 is prismatic and the top surface of the top of the supporting member 11 is rectangular, a central line or a diagonal line of the top surface is the center line.

In view of this, according to the heating module 100 of the embodiment, the heating main body 121 is configured to surround in the groove 13 of the supporting member 11, and the thermal conductive adhesive 10c is used to fill the gap between the housing member 10b and the heating assembly 10a, heating uniformity of the heating module 100 is improved.

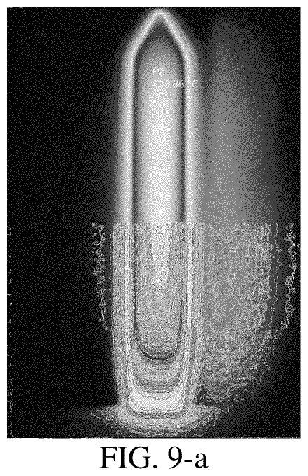

Specifically, please refer to FIG. 8, FIG. 0.8 is a heating effect diagram of a heating module in prior art. It can be known form the FIG. 8, a minimum temperature difference at any two positions in the heating module of the prior art is 12.92 centigrade (□), and a maximum temperature difference is 148.75 centigrade (□), that is, the heating module heats non-uniformly.

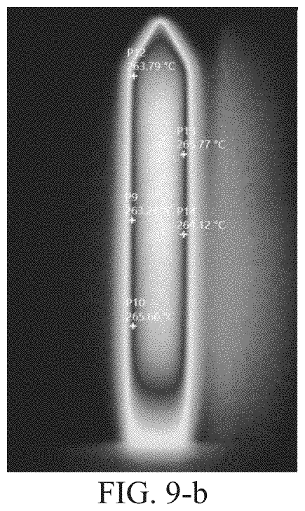

As to the heating module 100 of the embodiment, please refer to FIG. 9-a and FIG. 9-b. In FIG. 9-a, a minimum temperature difference at any two positions in the supporting member 11 of the heating module 100 is 2.65 centigrade (□); in FIG. 9-b, a maximum temperature difference at any two positions in the supporting member 11 of the heating module 100 is 1.87 centigrade (□); therefore, compared with FIG. 8, it is apparent that the heating module 100 of the present application heats more uniformly.

It should be noted that FIG. 8, FIG. 9-a and FIG. 9-b are heating effect diagrams of experiments performed in the same experimental environment.

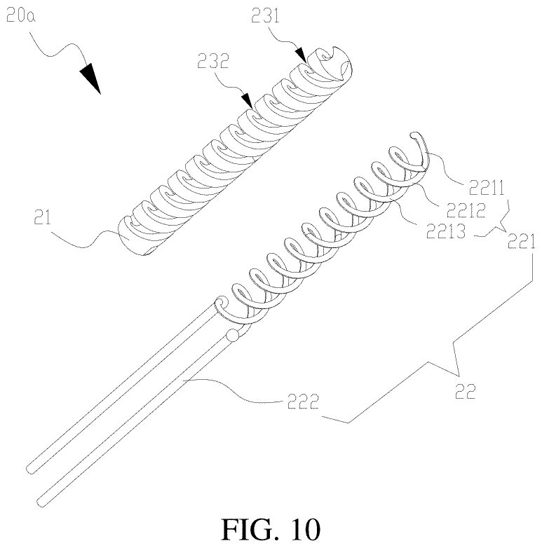

In some embodiments, please refer to FIG. 10, compared to the heating assembly 10a of this embodiment, the heating assembly 20a and the heating assembly 10a of this embodiment differ at that: no groove is provided on the top of the supporting member 21. That is to say, a first groove 231 and a second groove 232 are provided in an outer periphery of the supporting member 21. The first groove 231 and the second groove 232 twines from the top of the supporting member 21 to the bottom of the supporting member 21. The first groove 231 and the second groove 232 are disposed at an interval.

The heating coil 22 includes the heating main body 221, two pins 222 connected to the heating main body 221 and a conductive layer (not shown) covering the pins 222.

The heating main body 221 includes a first heating section 2211, a second heating section 2212 and a third heating section 2213. One end of the second heating section 2212 is connected to one end of the first heating section 2211, and the third heating section 2213 is connected to another end of the first heating section 2211.

The first heating section 2211 is mounted on the top of the supporting member 21. The second heating section 2212 is disposed inside the first groove 231. The third heating section 2213 is disposed inside the second groove 232.

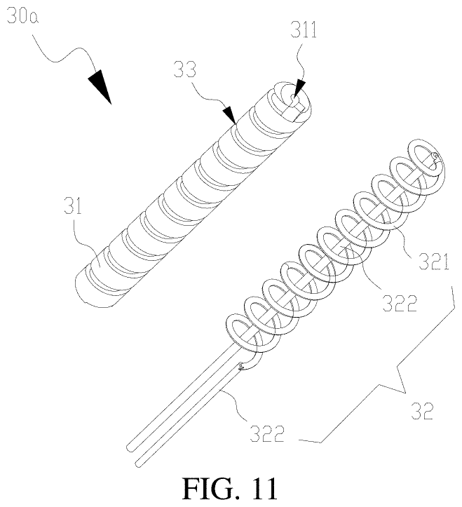

The twinning way of the heating coil 12 can be different with the above-mentioned embodiment, for example, in a single thread winding way different from the above-mentioned double thread winding way. Please refer to FIG. 11, the heating assembly 30a includes the supporting member 31 and the heating coil 32 twinning on the supporting member 32. The heating coil 32 includes the heating main body 321, two pins 322 connected to the heating main body 321 and a conductive layer (not shown) covering the pins 322.

A through-hole 311 penetrating the supporting member 31 is provided in the supporting member 31, and a depth direction of the through-hole 311 is an extending direction of the supporting member 31.

The peripheral wall of the supporting member 31 is provided with a groove 33 in a shape of screw thread. The heating main body 321 twines inside the groove 33. One of the pins 322 of the heating coil 32 is connected to one end of the heating main body 321 and extends into the through-hole 311 and out of the supporting member 31, and another of the pins 322 is connected to another end of the heating main body 321, and also exceeds the supporting member 31.

The present application also relates to a smoking device, which includes the heating assembly of anyone of the embodiments.

According to the heating module of this embodiment, the heating coil is arranged on the supporting member to form the heating assembly, and the heating assembly is used as heat source to heat the housing member to improve the overall heating uniformity of the heating module; moreover, the thermal conductive adhesive 10c is used to fill a gap between the heating module and the housing member, which allows the heating module transfer heat uniformly to the housing member, so as to improve the overall heating uniformity of the heating module.

The heating assembly and the smoking device provided by the implementations of the present application are described in detail above. Specific examples are utilized in the present disclosure to explain a principle and implementations of the present application. The description of the above implementations is only used to help understand the technical solution and a main idea of the present application. A person of ordinary skill in the art should understand that the technical solution described in each of the previous implementations may still be modified or some of technical features thereof may be replaced equivalently. However, these modifications or substitutions do not cause essences of the corresponding technical solutions to depart from a scope of the technical solution of each implementation of the present application.

What is claimed is:

1. A heating module, comprising:
a heating assembly comprising a supporting member and a heating coil, wherein at least part of the heating coil is arranged on the supporting member; and
a housing member disposed around an outer peripheral side of the heating assembly;
wherein a groove is arranged in an external surface of the supporting member, the heating coil comprises a heating main body, and the heating main body twines inside the groove.

2. The heating module according to the claim 1, wherein the supporting member comprises a supporting main body and an insulating layer, and the insulating layer is disposed on an external surface of the supporting main body.

3. The heating module according to the claim 2, wherein a thermal conductivity of the supporting main body is greater than or equal to 80 W/m·K.

4. The heating module according to the claim 3, wherein the supporting main body and the insulating layer are integrally formed by an insulating material.

5. The heating module according to the claim 3, wherein a material of the supporting main body is metal, and a material of the insulating layer comprises metal oxide formed on the supporting main body.

6. The heating module according to the claim 5, wherein the material of the supporting main body is one of gold, silver, copper, iron, aluminum or alloy, and the material of the insulating layer comprises one of alumina ceramics and zirconia.

7. The heating module according to the claim 6, wherein the material of the supporting main body is aluminum, and the material of the insulating layer comprises zirconia formed on the supporting main body.

8. The heating module according to the claim 1, wherein the heating module further comprises a thermal conductive adhesive, and the thermal conductive adhesive fills a gap between the heating assembly and the housing member.

9. The heating module according to the claim 8, wherein the thermal conductive adhesive is selected from ceramic inorganic adhesives or inorganic adhesives of glass enamel.

10. The heating module according to the claim 1, wherein the heating coil further comprises two pins and a conductive layer, the pins are connected to the heating main body, the conductive layer covers the periphery of the pins, and a resistivity of the conductive layer is lower than a resistivity of the pins.

11. The heating module according to the claim 10, wherein a material of the pins differs from a material of the heating main body, and the resistivity of the pins is lower than a resistivity of the heating coil.

12. The heating module according to the claim 10, wherein a material of the pins is the same as a material of the heating main body, and the pins are integrally formed with the heating main body.

13. The heating module according to the claim 10, wherein a material of the conductive layer is selected from one or a combination of more than two of silver, copper, and gold.

14. The heating module according to the claim 1, wherein the groove comprises a first groove, a second groove and a third groove, the second groove is connected to an end of the first groove, and the third groove is connected to another end of the first groove; and
the first groove is arranged in a top of the supporting member, either of the second groove and the third groove twines from the top of the supporting member to a bottom of the supporting member, respectively, and the second groove and the third groove are disposed at an interval;
the heating main body comprises a first heating section, a second heating section and a third heating section, the second heating section is connected to an end of the first heating section, the third heating section is connected to another end of the first heating section; and
the first heating section is disposed inside the first groove, the second heating section is disposed inside the second groove, and the third heating section is disposed inside the third groove.

15. The heating module according to the claim 14, wherein the first groove is disposed on a central line of the top of the supporting member.

16. The heating module according to the claim 10, wherein a through-hole penetrating the supporting member is provided in the supporting member, a depth direction of the through-hole is an extending direction of the supporting member; and
the groove in a shape of a screw thread is provided in a peripheral wall of the supporting member, the heating main body twines in the groove, one of the pins of the heating coil is connected to an end of the heating main body and extends into the through-hole and out of the supporting member; and another one of the pins of the heating coil is connected to another end of the heating main body, and also extends out of the supporting member.

17. The heating module according to the claim 1, wherein a first groove and a second groove are provided in a peripheral side of the supporting member, and either of the first groove and the second groove twines form a top of the supporting member to a bottom of the supporting member, respectively, the first groove and the second groove disposed at an interval;
the heating main body comprises a first heating section, a second heating section and a third heating section, the second heating section is connected to one end of the first heating section, the third heating section is connected to another end of the first heating section; and
the first heating section is mounted on the top of the supporting member, the second heating section is disposed inside the first groove, and the third heating section is disposed inside the second groove.

18. A smoking device, comprising a heating module, wherein the heating module comprises:
a heating assembly comprising a supporting member and a heating coil, wherein at least part of the heating coil is arranged on the supporting member; and
a housing member disposed around an outer peripheral side of the heating assembly;
wherein a groove is arranged in an external surface of the supporting member, the heating coil comprises a heating main body, and the heating main body twines inside the groove.

19. The smoking device according to the claim 18, wherein the supporting member comprises a supporting main body and an insulating layer, and the insulating layer is disposed on the external surface of the supporting member.

20. The smoking device according to the claim 19, wherein a thermal conductivity of the supporting main body is greater than or equal to 80 W/m·K.
